(19) United States
(12) Patent Application Publication
(10) Pub. No.: US 2021/0402848 A1
(43) Pub. Date: Dec. 30, 2021

(54) VEHICLE AIR CONDITIONER

(71) Applicant: HONDA MOTOR CO., LTD., Tokyo (JP)

(72) Inventors: Osamu Ishida, Tokyo (JP); Ryosuke Mimura, Tochigi (JP)

(21) Appl. No.: 17/355,220

(22) Filed: Jun. 23, 2021

(30) Foreign Application Priority Data
Jun. 26, 2020 (JP) 2020-110191

(51) Int. Cl. B60H 1/00; B60H 1/24

(52) U.S. Cl. CPC B60H 1/00849; B60H 1/00764; B60H 1/247; B60H 1/00671

(57) ABSTRACT

A vehicle air conditioner includes an external air introduction port, an internal air introduction port, an internal/external air-switching door, an air blower, a plurality of types of blowing ports, an internal/external air changeover switch, and a control device. The plurality of types of blowing ports blow conditioning air from a place that corresponds to a selected blowing mode. Even in a case where the internal/external air changeover switch is operated such that the external air introduction port is opened, when a blowing mode that opens a predetermined blowing port having a large total opening area among the blowing ports is selected and when an output of the air blower is equal to or more than a predetermined value, the control device controls the internal/external air-switching door such that the internal air introduction port is partially opened.

### CROSS-REFERENCE TO RELATED APPLICATION

Priority is claimed on Japanese Patent Application No. 2020-110191, filed on Jun. 26, 2020, the contents of which are incorporated herein by reference.

### BACKGROUND

### Field of the Invention

The present invention relates to a vehicle air conditioner.

### Background

In a vehicle air conditioner, an external air introduction port for introducing air from the outside of a vehicle and an internal air introduction port for introducing air from the inside of a vehicle room are disposed on an upstream side of an air conditioning unit that includes functions such as heating, cooling, or dehumidification. An internal/external air-switching door that opens and closes the external air introduction port and the internal air introduction port and that switches between external air introduction and internal air introduction is provided on the air conditioning unit. An air blower that suctions air from one of the external air introduction port and the internal air introduction port and sends air to the downstream side is provided on the air conditioning unit. A vent blowing port that blows conditioning air to an upper body of an occupant in the vehicle room, a floor blowing port that blows conditioning air to the foot of the occupant in the vehicle room, and a defroster blowing port that blows conditioning air to an inner surface of a wind shield glass inside the vehicle room are disposed on the downstream side of the air conditioning unit (for example, refer to Japanese Unexamined Patent Application, First Publication No. 2017-213972).

### SUMMARY

The upstream side of the external air introduction port of the vehicle air conditioner is connected to an introduction passage that continues to the inside of a dash upper member from a cowl top panel below the wind shield glass. At the time of traveling in rainy weather, a large amount of rainwater that flows into the introduction passage may be carried by an external air stream and may flow in the direction of the external air introduction port. In this situation, when the external air introduction port of the vehicle air conditioner is fully opened by an internal/external air changeover switch, there is a possibility that rainwater that is mixed in the external air may enter the inside of the external air introduction port by the momentum of the external air and may drop into the vehicle room via a gap of a casing of the air conditioning unit.

An aspect of the present invention provides a vehicle air conditioner that is capable of preventing water droplets such as rainwater from flowing into a vehicle room via an external air introduction port even when an internal/external air changeover switch may be operated such that an external air introduction port is opened at the time of traveling in rainy weather or the like.

A vehicle air conditioner according to an aspect of the present invention includes: an external air introduction port that introduces air from an outside of a vehicle;

an internal air introduction port that introduces air from an inside of a vehicle room; an internal/external air-switching door that opens and closes the external air introduction port and the internal air introduction port; an air blower that suctions air from at least one of the external air introduction port and the internal air introduction port and sends the air to a downstream side; a plurality of types of blowing ports that blow conditioning air from a place that corresponds to a selected blowing mode; an internal/external air changeover switch that switches an opening/closing state of the external air introduction port and the internal air introduction port by the internal/external air-switching door; and a control device that controls an operation of the internal/external air-switching door, wherein even in a case where the internal/external air changeover switch is operated such that the external air introduction port is opened, when a blowing mode that opens a predetermined blowing port having a large total opening area among the blowing ports is selected and when an output of the air blower is equal to or more than a predetermined value, the control device controls the internal/external air-switching door such that the internal air introduction port is partially opened.

According to the configuration described above, even in a case where the internal/external air changeover switch is operated such that the external air introduction port is opened, when a blowing mode condition and an air blower output condition described below are satisfied, the internal air introduction port is partially opened.

Blowing mode condition: a blowing mode in which the total opening area of the blowing port becomes large is selected.

Air blower output condition: the output of the air blower is equal to or more than the predetermined value.

Thereby, even when the internal/external air changeover switch may be operated such that the external air introduction port is opened at the time of traveling in rainy weather or the like, part of the air that is suctioned by the air blower becomes air inside the vehicle room when the conditions described above are satisfied. As a result, the flow rate of the introduced external air is reduced, and water droplets such as rainwater that are mixed in the external air are prevented from flowing into the inside of the vehicle room.

The plurality of types of blowing ports may include a vent blowing port that blows conditioning air to an upper body side of an occupant and a floor blowing port that blows conditioning air to a foot side of the occupant, and the blowing mode may be a mode in which the vent blowing port is opened independently and a mode in which both the vent blowing port and the floor blowing port are opened.

Commonly, the opening area of the vent blowing port that blows conditioning air to the upper body side of the occupant is set to be large such that the largest amount of air can be obtained. Therefore, in the blowing mode in which the vent blowing port is opened independently and in the blowing mode in which both the vent blowing port and the floor blowing port are opened, the amount of conditioning air that is blown from the blowing port becomes large. Therefore, when the blowing mode condition is that any one of the mode in which the vent blowing port is opened independently and the mode in which both the vent blowing port and the floor blowing port are opened, it is possible to efficiently prevent water droplets such as rainwater from flowing to the inside of the vehicle room at the time of traveling in rainy weather or the like.

The control device may maintain the internal air introduction port in a closed state in a case where a vehicle speed is larger than a predetermined speed even when a blowing mode that opens the predetermined blowing port having a large total opening area is selected, and the output of the air blower is equal to or more than the predetermined value in a state where the internal/external air changeover switch is operated such that the external air introduction port is opened.

Even in a case where the blowing mode condition and the air blower output condition are satisfied, in a case where the vehicle speed is larger than the predetermined speed, the internal air introduction port is not opened. That is, under a situation in which the flow speed of the external air that flows in the external air introduction port becomes extremely fast due to the vehicle speed, the internal air introduction port is not opened. Therefore, it is possible to prevent a large amount of external air from flowing to the inside of the vehicle room via the internal air introduction port by the internal air introduction port being opened. Accordingly, when the present configuration is employed, it is possible to eliminate a feeling of discomfort of the occupant inside the vehicle room due to the direct inflow of the external air that does not pass through the air conditioning unit into the vehicle room.

In an aspect of the present invention, at the time of traveling in rainy weather or the like, even when the internal/external air changeover switch may be operated such that the external air introduction port is opened, when the blowing mode is a mode that opens the predetermined blowing port having a large total opening area and when the output of the air blower is equal to or more than the predetermined value, the internal air introduction port is partially opened. Accordingly, when an aspect of the present invention is employed, it is possible to prevent water droplets such as rainwater from flowing into the vehicle room via the external air introduction port even when the internal/external air changeover switch may be operated such that the external air introduction port is opened at the time of traveling in rainy weather or the like.

### BRIEF DESCRIPTION OF THE DRAWINGS

FIG. 1 is a longitudinal cross-sectional view of a vehicle air conditioner of an embodiment and a vehicle in which the vehicle air conditioner is mounted.

FIG. 2 is a longitudinal cross-sectional view of the vehicle air conditioner of the embodiment and the vehicle in which the vehicle air conditioner is mounted.

FIG. 3 is a flow chart showing a control of the vehicle air conditioner of the embodiment.

### DESCRIPTION OF EMBODIMENTS

Hereinafter, an embodiment of the present invention will be described with reference to the drawings. In the drawings, an arrow FR that indicates a frontward direction of a vehicle 1 and an arrow UP that indicates an upward direction of the vehicle are shown.

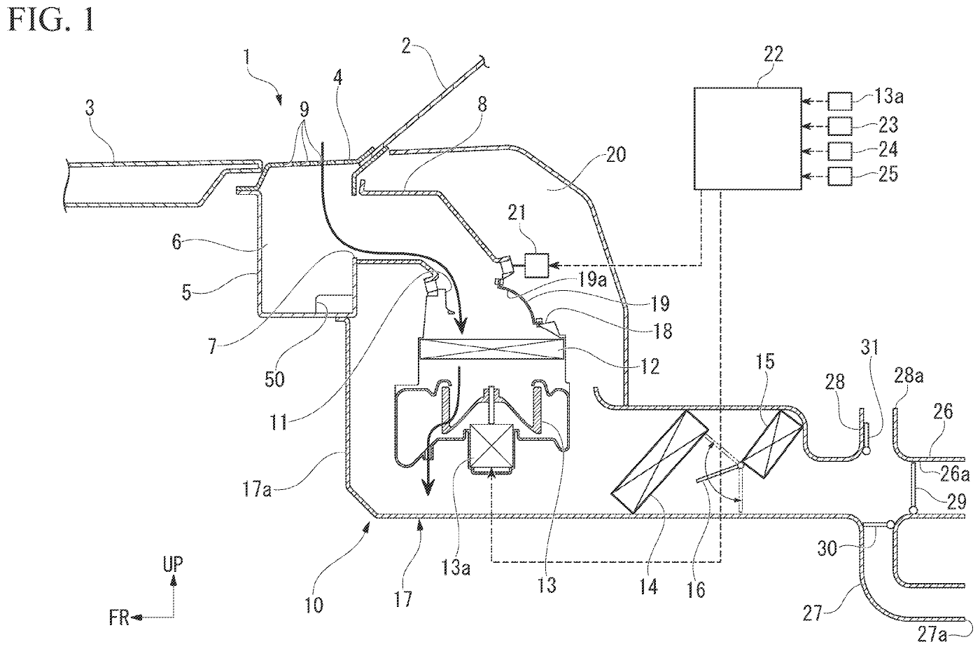

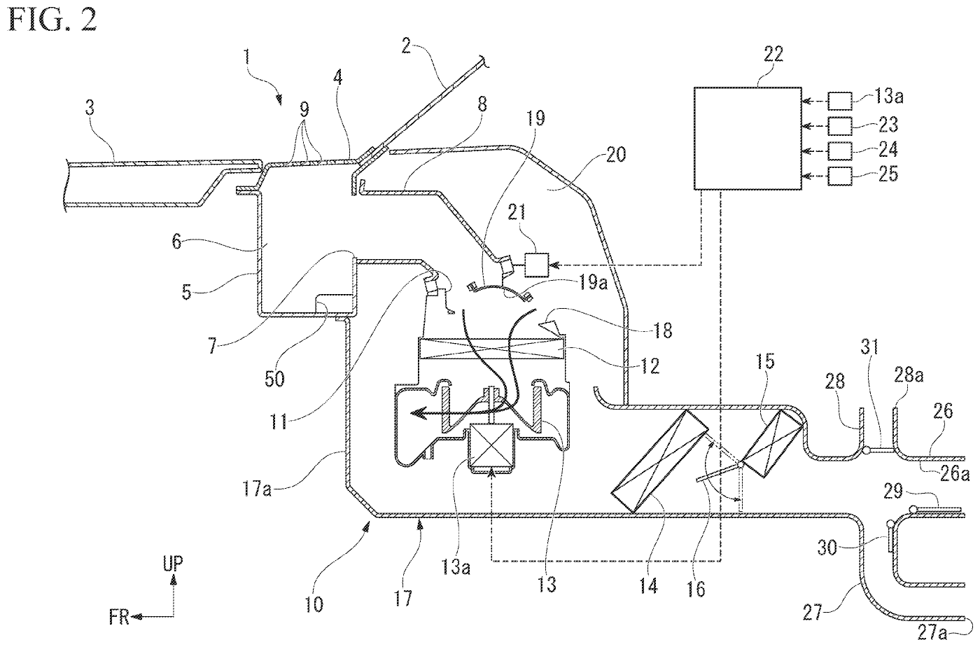

FIG. 1 and FIG. 2 are longitudinal cross-sectional views of a vehicle air conditioner 10 of the present embodiment and the vehicle 1 in which the vehicle air conditioner 10 is mounted. FIG. 1 and FIG. 2 differ from each other only in an operation position of the internal/external air-switching door 19 described later and in a blowing mode of conditioning air.

A reference numeral 2 in the drawing represents a wind shield glass in front of a front seat of the vehicle 1. A reference numeral 3 represents an engine hood that covers an upper part of an engine room at a front part of the vehicle. A cowl top panel 4 is disposed at a front lower side of the wind shield glass 2. A dash upper panel 5 is disposed below the cowl top panel 4. A space between the cowl top panel 4 and the dash upper panel 5 is an introduction passage 6 that guides external air to an external air introduction port 11 of the vehicle air conditioner 10. A penetration hole 7 that faces the introduction passage 6 is formed on the dash upper panel 5. The penetration hole 7 is connected to the external air introduction port 11 of the vehicle air conditioner 10 via a connection duct 8.

A communication hole 9 that concurrently serves to introduce the external air and discharge water droplets such as rainwater is formed on the cowl top panel 4. At a lower position of the wind shield glass 2, water droplets that have dropped downward from the communication hole 9 flow through a bottom part of the introduction passage 6 in a vehicle width direction and are then discharged to the outside of the vehicle via a water discharge hole 50 at the outside in the vehicle width direction. Air outside the vehicle 1 that flows from the communication hole 9 into the introduction passage 6 is introduced to the external air introduction port 11 via the penetration hole 7 and the connection duct 8.

The vehicle air conditioner 10 includes an air conditioning unit 17 having an air filter 12, an air blower 13, an evaporator 14, a heater core 15, an air mix door 16, and the like. The air blower 13, the evaporator 14, and the heater core 15 are arranged in this order from an upstream side toward a downstream side in an air flow direction inside a casing 17a of the air conditioning unit 17. An external air introduction port 11 that introduces air from the outside of the vehicle 1 and an internal air introduction port 18 that introduces air from the inside of the vehicle room are formed on an upstream end in the air flow direction of the casing 17a. The external air introduction port 11 and the internal air introduction port 18 are opened and closed by the internal/external air-switching door 19.

The air filter 12 is disposed between the external air introduction port 11 and the air blower 13 and between the internal air introduction port 18 and the air blower 13. The evaporator 14 cools the introduced air by vaporization heat of a refrigerant. The heater core 15 heats the introduced air using heat of an engine coolant or heat that is generated by a heat pump system. The air mix door 16 is rotatable by an actuator (not shown) and adjusts the ratio of air that passes through the heater core 15 in accordance with a rotation position.

When being opened by the internal/external air-switching door 19, the external air introduction port 11 introduces external air into the casing 17a via the introduction passage 6 and the connection duct 8 described above. When being opened by the internal/external air-switching door 19, the internal air introduction port 18 introduces air inside the vehicle room into the casing 17a via the internal air introduction passage 20. In the case of the present embodiment, the external air introduction port 11 and the internal air introduction port 18 are arranged adjacent to each other at an end part on the upstream side of the casing 17a such that the entering directions of the introduced air cross with each other.

The internal/external air-switching door 19 is slidably displaceable between a first position at which the internal air introduction port 18 is fully closed and the external air introduction port 11 is fully opened and a second position at which the internal air introduction port 18 is fully opened and the external air introduction port 11 is fully closed. In the case of the present embodiment, the internal/external air-switching door 19 slides in an arc-like manner by being driven by a door operation actuator 21 such as a motor. An inner side surface 19a of the internal/external air-switching door 19 is constituted of a curved surface having an arc shape. The curved shape of the inner side surface 19a is formed in a curved shape substantially along a slide track having an arc shape of the internal/external air-switching door 19. Therefore, when one of the external air introduction port 11 and the internal air introduction port 18 is closed, the internal/external air-switching door 19 can guide air that is introduced from the other introduction port in the direction of the air filter 12 (air blower 13) along the inner side surface 19a having an arc shape.

The door operation actuator 21 is controlled by a control device 22. Therefore, the opening and closing operation of the external air introduction port 11 and the internal air introduction port 18 by the internal/external air-switching door 19 is controlled by the control device 22.

The air blower 13 includes a drive motor 13a that is driven by a control by the control device 22. The air blower 13 suctions air from at least one of the external air introduction port 11 and the internal air introduction port 18 and sends the air to the downstream side (evaporator 14 side). Output information (for example, a drive voltage or a rotation number) of the drive motor 13a (air blower 13) is fed back to the control device 22.

State information of the internal/external air changeover switch 23 that is operated by the operator, vehicle speed information from a vehicle speed sensor 24, detection information from a blowing mode detection part 25 that detects a blowing mode described later, and the like in addition to the output information of the drive motor 13a (air blower 13) are input to the control device 22.

A vent passage 26, a foot passage 27, and a defroster passage 28 are connected to the downstream side of the air conditioning unit 17 in a triply branched state. An end part on the vehicle inner side of the vent passage 26 is a vent blowing port 26a for blowing conditioning air to the upper body of the occupant in the vehicle room. An end part on the vehicle inner side of the foot passage 27 is a floor blowing port 27a for blowing conditioning air to the foot of the occupant in the vehicle room. An end part on the vehicle inner side of the defroster passage 28 is a defroster blowing port 28a for blowing conditioning air to the inner surface of the wind shield glass 2 in the vehicle room. The vent blowing port 26a, the floor blowing port 27a, and the defroster blowing port 28a are operated to be opened and closed by opening/closing doors 29, 30, and 31, respectively.

The total opening area of the vent blowing port 26a is set to be the largest among the three types of blowing ports described above since the vent blowing port 26a sends conditioning air to the upper body side of the occupant. Therefore, the blowing amount of conditioning air that is blown out of the vent blowing port 26a is the largest among those of the three types of blowing ports.

The vehicle air conditioner 10 includes a plurality of blowing modes having a different blowing port that blows the conditioning air. The blowing mode includes, for example, the following types.

(1) Vent blowing mode: a blowing mode in which conditioning air is blown out of the vent blowing port 26a.

(2) Foot blowing mode: a blowing mode in which conditioning air is blown out of the floor blowing port 27a.

(3) Defroster blowing mode: a blowing mode in which conditioning air is blown out of the defroster blowing port 28a.

(4) B/L blowing mode: a blowing mode in which conditioning air is blown out of the vent blowing port 26a and the floor blowing port 27a.

When an auto operation is selected, these blowing modes are selected by the control device 22 in accordance with a set temperature, an ambient temperature, and the like. When a blowing select switch is operated, these blowing modes are selected by the switch operation. In the B/L blowing mode, since both the vent blowing port 26a and the floor blowing port 27a are opened, when the vehicle air conditioner 10 is operated in the B/L blowing mode, the blowing amount of the conditioning air is larger than that in a case where the vehicle air conditioner 10 is operated in the vent blowing mode.

In the vehicle air conditioner 10, when the auto operation is selected, the control device 22 selects operation modes such as cooling, heating, dehumidification, and blowing in accordance with the set temperature, the ambient temperature, and the like. When an operation mode selection switch is operated, the operation mode is selected by the switch operation.

In the air blower 13, when the auto operation is selected, the output (air amount) is selected by the control device 22 in accordance with the set temperature, the ambient temperature, and the like. When an air amount selection switch is operated, an air amount is selected by the switch operation.

The internal/external air-switching door 19 receives an operation of the internal/external air changeover switch 23 and selectively opens the external air introduction port 11 and the internal air introduction port 18. However, even when the internal/external air changeover switch 23 is operated such that the external air introduction port 11 is fully opened, the internal air introduction port 18 is partially opened by the internal/external air-switching door 19 by the control of the drive motor 13a by the control device 22 when the following specific conditions (a), (b), and (c) are satisfied. The opening amount of the internal air introduction port 18 at this time is, for example, about 30% when the fully opened state is 100%.

### <Condition Where Internal Air Introduction Port 18 is Partially Opened>

(a) The blowing mode is the vent blowing mode or the B/L blowing mode (a blowing mode in which a predetermined blowing port having a large total opening area is opened).

(b) An output Vf of the air blower 13 is equal to or more than a predetermined value (for example, the drive voltage is 11.6 V or more).

(c) A vehicle speed is equal to or less than a predetermined speed v1 (for example, 115 km/h or less).

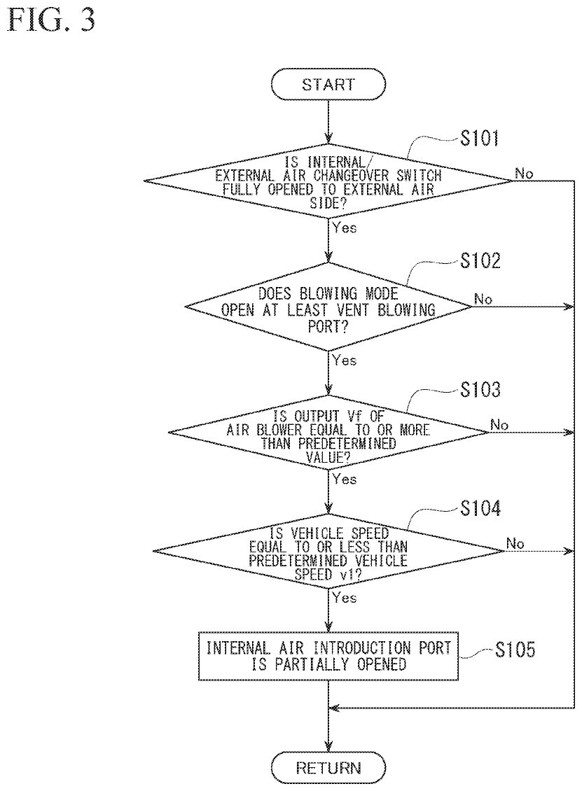

FIG. 3 is a flow chart showing an example of a control by the control device 22 in a case where the internal/external air changeover switch 23 is operated such that the external air introduction port 11 is fully opened.

Hereinafter, an example of a control by the control device 22 is described with reference to the flow chart of FIG. 3.

In Step S101, it is determined whether or not the internal/external air changeover switch 23 is operated to a side at which the external air introduction port 11 is fully opened. When the internal/external air changeover switch 23 is operated to the side at which the external air introduction port 11 is fully opened, the routine proceeds to Step S102. When the internal/external air changeover switch 23 is operated to a side at which the external air introduction port 11 is fully closed, the routine completes the process (returns).

In Step S102, it is determined whether or not the blowing mode of the vehicle air conditioner 10 is a blowing mode which is any of the vent blowing mode and the B/L blowing mode. That is, it is determined whether or not the blowing mode includes at least the vent blowing port and is a blowing mode in which the blowing opening area is sufficiently large. When the blowing mode is a blowing mode which is any of the vent blowing mode and the B/L blowing mode, the routine proceeds to the next Step S103. When the blowing mode is another blowing mode, the routine completes the process (returns).

In Step S103, it is determined whether or not the output Vf (drive voltage) of the air blower 13 is equal to or more than the predetermined value. When the output Vf of the air blower 13 is equal to or more than the predetermined value, the routine proceeds to the next Step S104. When the output Vf is less than the predetermined value, the routine completes the process (returns).

In Step S104, it is determined whether or not the vehicle speed is equal to or less than the predetermined vehicle speed v1. When the vehicle speed is equal to or less than the predetermined vehicle speed v1, the routine proceeds to the next Step S105. When the vehicle speed is more than the predetermined vehicle speed vl, the routine completes the process (returns). That is, only when all of the above conditions (a), (b), and (c) are satisfied does the routine proceed to Step S105.

In Step S105, the door operation actuator 21 is controlled such that the internal air introduction port 18 is opened by about 30%. Thereby, the internal air introduction port 18 is opened by about 30%, and accordingly, the opening degree of the external air introduction port 11 is narrowed to about 70%. As a result, the flow rate of the external air that is introduced into the external air introduction port 11 via the introduction passage 6 and the connection duct 8 is reduced, and even when water droplets such as rainwater are mixed in the external air, the entry of water droplets into the air conditioning unit 17 is prevented.

When the vehicle speed is higher than the predetermined vehicle speed vl, since the process of Step S105 is not performed, the external air that flows into the external air introduction port 11 at a high speed due to the travel wind does not flow directly into the vehicle room via the internal air introduction port 18.

As described above, in the vehicle air conditioner 10 of the present embodiment, even when the internal/external air changeover switch 23 is operated such that the external air introduction port 11 is fully opened, in a case where the conditions (a) and (b) described above at a vehicle speed that is equal to or less than the predetermined vehicle speed v1 are satisfied, the internal air introduction port 18 is partially opened by the control by the control device 22. Therefore, even when the internal/external air changeover switch 23 may be operated such that the external air introduction port 11 is fully opened at the time of traveling in rainy weather or the like, when all of the above conditions (a) and (b) are satisfied, part of the air that is suctioned by the air blower 13 becomes air inside the vehicle room.

Accordingly, when the vehicle air conditioner 10 of the present embodiment is employed, the flow rate of the introduced external air is reduced, and water droplets such as rainwater that are mixed in the external air are prevented from flowing into the inside of the vehicle room.

Further, in the vehicle air conditioner 10 of the present embodiment, with respect to the blowing mode condition when the internal air introduction port 18 is partially opened by the control by the control device 22, any of the vent blowing mode and the B/L blowing mode is selected as the blowing mode.

Since the opening area of the vent blowing port 26a that blows conditioning air to the upper body side of the occupant is set to be large such that the largest amount of air can be obtained, when the vent blowing mode or the B/L blowing mode in which the vent blowing port 26a is opened is selected, the amount of conditioning air that is blown from the blowing port becomes sufficiently large. Accordingly, when the present configuration is employed, it is possible to efficiently prevent water droplets such as rainwater from flowing to the inside of the vehicle room at the time of traveling in rainy weather or the like.

Further, in the vehicle air conditioner 10 of the present embodiment, the condition (c), that is, a condition in which the vehicle speed is equal to or less than the predetermined vehicle speed v1 is added to the conditions (a) and (b) described above as a condition that partially opens the internal air introduction port 18 by the control by the control device 22 when the internal/external air changeover switch 23 is operated such that the external air introduction port 11 is fully opened. Therefore, even when the conditions (a) and (b) described above are satisfied, the internal air introduction port 18 is not opened by the control by the control device 22 in a case where the vehicle speed is a speed that exceeds the predetermined vehicle speed v1 (for example, 115 km/h). Therefore, when the vehicle 1 is traveling at a speed that exceeds the predetermined vehicle speed v1, it is possible to prevent a large amount of external air from flowing directly to the inside of the vehicle room via the internal air introduction port 18 by the internal air introduction port 18 being opened.

Accordingly, when the vehicle air conditioner 10 of the present embodiment is employed, it is possible to eliminate an inconvenience in which external air that is not air-conditioned by the air conditioning unit 17 flows directly into the vehicle room and causes discomfort to the occupant in the vehicle room.

Further, the internal/external air-switching door 19 employed in the vehicle air conditioner 10 of the present embodiment is slidably displaceable between the first position at which the internal air introduction port 18 is fully closed and the external air introduction port 11 is fully opened and the second position at which the internal air introduction port 18 is fully opened and the external air introduction port 11 is fully closed. The inner side surface 19a of the internal/external air-switching door 19 is constituted of a curved surface having an arc shape along the slide track of the internal/external air-switching door 19. Therefore, when the internal/external air-switching door 19 is operated so as to partially open the internal air introduction port 18 at the time of introduction of the external air, the air inside the vehicle room that flows from the internal air introduction port 18 into the air conditioning unit 17 is guided to the curved surface on the inside of the internal/external air-switching door 19 and is diverted to the direction of the external air introduction port 11. Thereby, it is possible to prevent the sudden flow of external air from the external air introduction port 11 by the flow of internal air.

Accordingly, when the configuration of the internal/external air-switching door 19 of the present embodiment is employed, it is possible to further prevent water droplets such as rainwater that is mixed in the external air from flowing to the inside of the vehicle room when the internal/external air changeover switch 23 is operated such that the external air introduction port 11 is fully opened.

The present invention is not limited to the embodiment described above, and various design changes can be made without departing from the scope of the invention. For example, in the embodiment described above, the condition in which the vehicle speed is equal to or less than the predetermined vehicle speed v1 is one of the conditions for the internal/external air-switching door 19 to partially open the internal air introduction port 18; however, this condition may be eliminated.

Further, in the embodiment described above, since a lower limit value of the vehicle speed is not set as a condition for the internal/external air-switching door 19 to partially open the internal air introduction port 18, when the conditions (a), (b), and (c) described above are satisfied even at the time of stopping of the vehicle, the internal/external air-switching door 19 partially opens the internal air introduction port 18.

However, as another embodiment, it is possible to set a lower limit value of the vehicle speed as a condition for the internal/external air-switching door 19 to partially open the internal air introduction port 18. That is, a condition in which the vehicle speed is equal to or more than another predetermined speed (for example, 10 km/h or more) that is less than the predetermined speed of the condition (c) described above may be added as a new condition. In this case, the internal air introduction port 18 can be partially opened only when water droplets such as rainwater further easily enters the air conditioning unit 17 from the external air introduction port 11 due to the impact of the travel wind.

What is claimed is:

1. A vehicle air conditioner, comprising:
an external air introduction port that introduces air from an outside of a vehicle;
an internal air introduction port that introduces air from an inside of a vehicle room;
an internal/external air-switching door that opens and closes the external air introduction port and the internal air introduction port;
an air blower that suctions air from at least one of the external air introduction port and the internal air introduction port and sends the air to a downstream side;
a plurality of types of blowing ports that blow conditioning air from a place that corresponds to a selected blowing mode;
an internal/external air changeover switch that switches an opening/closing state of the external air introduction port and the internal air introduction port by the internal/external air-switching door; and
a control device that controls an operation of the internal/external air-switching door,
wherein even in a case where the internal/external air changeover switch is operated such that the external air introduction port is opened, when a blowing mode that opens a predetermined blowing port having a large total opening area among the blowing ports is selected and when an output of the air blower is equal to or more than a predetermined value, the control device controls the internal/external air-switching door such that the internal air introduction port is partially opened.

2. The vehicle air conditioner according to claim 1,
wherein the plurality of types of blowing ports include a vent blowing port that blows conditioning air to an upper body side of an occupant and a floor blowing port that blows conditioning air to a foot side of the occupant, and
the blowing mode is a mode in which the vent blowing port is opened independently and a mode in which both the vent blowing port and the floor blowing port are opened.

3. The vehicle air conditioner according to claim 1,
wherein the control device maintains the internal air introduction port in a closed state in a case where a vehicle speed is larger than a predetermined speed even when a blowing mode that opens the predetermined blowing port having a large total opening area is selected, and the output of the air blower is equal to or more than the predetermined value in a state where the internal/external air changeover switch is operated such that the external air introduction port is opened.

4. The vehicle air conditioner according to claim 2,
wherein the control device maintains the internal air introduction port in a closed state in a case where a vehicle speed is larger than a predetermined speed even when a blowing mode that opens the predetermined blowing port having a large total opening area is selected, and the output of the air blower is equal to or more than the predetermined value in a state where the internal/external air changeover switch is operated such that the external air introduction port is opened.
